(19) United States
(12) Patent Application Publication
(10) Pub. No.: US 2019/0020664 A1
(43) Pub. Date: Jan. 17, 2019

(54) System and Method for Blocking Persistent Malware

(71) Applicant: Michael C. Wood, Wilton Manors, FL (US)

(72) Inventor: Michael C. Wood, Wilton Manors, FL (US)

(21) Appl. No.: 16/116,386

(22) Filed: Aug. 29, 2018

Related U.S. Application Data
(63) Continuation-in-part of application No. 15/429,073, filed on Feb. 9, 2017.
(60) Provisional application No. 62/552,238, filed on Aug. 30, 2017.
(60) Provisional application No. 62/295,315, filed on Feb. 15, 2016.
(60) Provisional application No. 62/314,225, filed on Mar. 28, 2016.
(60) Provisional application No. 62/328,912, filed on Apr. 28, 2016.
(60) Provisional application No. 62/348,518, filed on Jun. 10, 2016.
(60) Provisional application No. 62/350,556, filed on Jun. 15, 2016.
(60) Provisional application No. 62/354,588, filed on Jun. 24, 2016.
(60) Provisional application No. 62/395,021, filed on Sep. 15, 2016.
(60) Provisional application No. 62/439,778, filed on Dec. 28, 2016.

(51) Int. Cl. H04L 29/06

(52) U.S. Cl. CPC H04L 63/145; H04L 63/1483; H04L 63/10

(57) ABSTRACT

Systems and methods for allowing and blocking data packets sent to and from browser software applications and non-browser software applications operated on a computing device are described as well as systems and methods for preventing infection by phishing sites. The system uses a firewall to block data packets to and from web addresses that are not owned by the maker of the application, are not trusted by the consensus trusted computing devices, or are blocked by selection by a user of the computing device. The system can show the identity of the owner of a link's site, prior to connecting to the site, to enable a user to decide whether the owner matches the expectation created by the surrounding context.

### CROSS-REFERENCE TO RELATED APPLICATIONS

This application is a nonprovisional application of and claims priority from U.S. provisional patent application Ser. No. 62/552,238 filed on Aug. 30, 2017; and is a continuation-in-part nonprovisional application of and claims priority from U.S. nonprovisional patent application Ser. No. 15/429,073 filed on Feb. 9, 2017, which is a nonprovisional of and claims the benefit of the following: U.S. provisional patent application Ser. No. 62/295,315 filed on Feb. 15, 2016, U.S. provisional patent application Ser. No. 62/314,225 filed on Mar. 28, 2016, U.S. provisional patent application Ser. No. 62/328,912 filed on Apr. 28, 2016, U.S. provisional patent application Ser. No. 62/348,518 filed on Jun. 10, 2016, U.S. provisional patent application Ser. No. 62/350,556 filed on Jun. 15, 2016, U.S. provisional patent application Ser. No. 62/354,588 filed on Jun. 24, 2016, U.S. provisional patent application Ser. No. 62/395,021 filed on Sep. 15, 2016, and U.S. provisional patent application Ser. No. 62/439,778 filed on Dec. 28, 2016. All of the foregoing applications and U.S. nonprovisional patent application Ser. No. 15/452,481 filed on Mar. 7, 2017 (now issued U.S. Pat. No. 9,992,233) are incorporated in their entirety herein by reference.

### FIELD OF THE INVENTION

The invention relates to systems and methods for thwarting persistent malware. More particularly, the invention relates to systems and methods for detecting and blocking data packets sent to and from browser software applications and/or non-browser software applications operated on a computing device and infected with Trojans and/or other malware that attempts to communicate with one or more hacker's command and control centers, and for preventing the uploading of Trojans and other malware by preventing a user from visiting phishing sites that host Trojans and other malware.

### BACKGROUND

According to the “2016 Verizon Data Breach Investigations Report,” the most prevalent form of hacking in 2016 was persistent malware installed via phishing. Such Trojans secretly connect infected computing devices to hackers' command and control centers. These Trojans use a systematic method to evade detection so that they can remain persistently undetected. The Trojans wait for a reputable application (“app”) to access the Internet, and then inject a copy of their code into the reputable app. Since firewalls and antivirus software only see the reputable app, they allow the injected code unfettered access to the Internet (and thereby, unfettered access to the hacker's command and control center).

Persistent malware has been a longstanding problem for the cybersecurity industry. The industry's failure to find adequate solutions is highlighted by how popular this longstanding hacking method has become.

A great need exists to finally be able to expose and block persistent malware. A further need exists to be able to detect and block Internet traffic to and from Trojans with which a computing device is infected while ensuring that the legitimate traffic to and from the infected apps is allowed.

The term “phishing” was first used in 1996 when attacks were made against AOL users. Now, twenty-one years later, phishing has only grown into a more pervasive, more troubling form of attack. In fact, 85% of organizations are aware of at least one phishing attack against them, and phishing has become the number one method of delivering malicious apps. The average cost to companies of a successful spear phishing attack is more than $1.5 million per attack. The most problematic statistic is even more troubling: 97% of users are not able to identify a sophisticated phishing email.

For over twenty years, the cybersecurity industry has failed to provide a system and method to empower users to identify a sophisticated phishing email. The failure of the industry to do so despite billions spent shows that developing such a system and method has been beyond those ordinarily skilled in the art. The system and method described herein solves the phishing issue by finally empowering users to identify phishing emails—even before a connection is made to a phishing website.

Although the anti-phishing system and method disclosed herein is quite elegant, it is also both powerful and effective. Neither its unique inventiveness nor its efficacy should be overlooked due to the sheer elegance of the solution.

The anti-phishing system and method came from the following epiphany: Computers can never be certain of an email's context; yet, users always know this. For example, when a user clicks on an email expecting it to be “Paypal,” the user knows what he or she is expecting based on the context of the email. Meanwhile, a computer can never be certain whether the email claims to be Paypal itself, whether the email claims to be a lawsuit against Paypal, whether the email purports to be friend discussing Paypal, etc. Computers are notorious for getting context wrong. Determining and recognizing context is a human ability.

Within this epiphany lies both the problem and the solution! If the user is presented with information regarding the owner of a site, the user knows whether or not that owner matches the email's context. (The same holds for links in other apps and websites as well, including but not limited to texting, social media, messaging, and websites.) For example, if the email's context causes the user to expect the site to be owned by Paypal, it then becomes easy for the user to know that it is a phishing email if the site's owner is anyone different than Paypal. Therefore, by viewing the problem from this brand new perspective, an elegant solution is finally found: Show the user the owner of each site so that the user can match the owner to the expectation set by the email's context. (Likewise, show the owner of a link's site for other apps and websites, so that the human user can decide whether the owner matches the context or not—before a connection to the site is ever made.)

### SUMMARY

The invention relates to systems and methods for preventing exposure to Trojan malware and other malware by preventing a connection to a phishing site. In one form, a phishing site is a website or web page that purports to belong to, to be affiliated with, or to be related to a reputable source (e.g., to a bank or a retailer) in order to induce a user to provide personal information (e.g., financial information or login and password credentials). In another form, the phishing site may not include any content that causes it appear or purport to belong to, to be affiliated with, or to be related to a reputable source. The phishing site may include only malware that is installed on the user's computing device once a connection to the site is made and may not contain any content.

The user may be directed to the phishing site by, for example, a phishing email purporting to be from the reputable source, which contains a link on which the user clicks or otherwise selects to connect to a site. Based on the sender of the email or the content of the email or the appearance or wording of the link itself, the user may believe that the link is safe and is induced to select it to connect to the site, which in reality leads to a phishing site on which the user's personal information is stolen.

In yet another form, a phishing site is a site that installs Trojan malware or other malware on the user's computing device once the link is selected and a connection to the site is made. In still another form, a phishing site is a redirect to a malicious site, i.e., a site that includes malware or one or more links to phishing sites.

The system includes a computing device that is communicatively connected to a communications network and a software application being operated on the computing device. The software application provides content and a link to a site, and is capable of allowing the link to the site to be selected so that the computing device connects to the site. The system also includes an owner identification process to communicate an identity of an owner of the site, and a device for providing a communication of the identity of the owner of the site to a user.

The system also can include an owner-identity deduction system for deducing the identity of an expected owner of the site. The owner identification process communicates the identity deduced by the owner-identity deduction system to the device for providing a communication of the identity of the owner of the site, which then provides the communication to the user in visual or audible form. The system can further include a connection process for allowing the computing device to connect to the site if the identity of the expected owner matches a context of the content and for blocking the computing device from connecting to the site if the identity of the expected owner does not match the context of the content. This connection process can be automated or can require user input via a selection made by the user using an input device.

The invention also relates to systems and methods for detecting and blocking data packets sent to and from browser software applications and/or non-browser software applications installed on a computing device and infected with Trojans and/or other malware that attempts to communicate with one or more hacker's command and control centers. In exemplary embodiments, the system is capable of allowing and blocking data packets sent to and from both browser software applications and non-browser software applications installed on a computing device. In other embodiments, systems that allow and block traffic to and from only browser software applications or to and from only non-browser software applications may be used, although for providing the most effective computer security systems that perform both methods are used. The allowance and blocking of data packets to and from various sources may be performed automatically by the system or may be accomplished by action taken by a user of the computing device.

The systems and methods described herein can use whitelisting based on the maker of a non-browser software application being a trusted source of data packets sent to the non-browser application or based on consensus by one or more consensus trusted computing devices that connections made by an URL open in a browser software application are correct and trusted. The system uses a local firewall of the computing device to block data packets to and from web addresses (i.e., domains, subdomains, path names, or URLs) that are not owned by the makers of the application, that are not trusted by the consensus trusted computing devices, or that are blocked by affirmative selection for blocking by a user of the computing device. The system can also include a health monitor engine to ensure that a kernel drive of the system is operational and not disabled by malware, which would prevent the system from detecting and blocking traffic between the browser and non-browser software applications installed on a computing device and a hacker's command and control center.

A need exists for systems and methods that reveal the identity of the owner of a site, for which a link is provided in an email, document, web page, or non-browser software application, before the user selects the link and connects the user's computing device to the site. A need also exists for automating the allowing and blocking of connections to such sites based on a comparison of context of the content of the email, document, web page, or non-browser software application with the owner's identity. A further need exists for allowing mismatches between owner identity and the context of content to be reported to a service provider who may use such reported information to warn other users against clicking on or otherwise selecting such links to connect to such sites.

Accordingly, the invention features a system for detecting and blocking Trojan malware and other malware as follows: The system includes a computing device that is communicatively connected to a communications network, and a browser software application being operated on the computing device. The system also includes an open URL identification process to communicate an identity of a web address, wherein the web address is an open web address if it is open in the address bar of the browser software application. The system further includes an open connection tracking process that tracks at least one connection to a remote computing device made by the open web address. The open connection tracking process can report open connections as one or more of the following: domains, subdomains, path names, resource locations, URLs, IP addresses, and the like. The system also includes a firewall to intercept data packets sent to or from the browser software application. The firewall blocks data packets that are not being sent to or from the open web address or to or from the at least one connection of the open web address.

In another aspect, the invention can feature the web address being a URL name, a path name of a URL, a domain name of a URL, or a subdomain of a URL. The identity can be an owner name, a URL name, a path name of a URL, a domain name of a URL, a subdomain of a URL, a derivative of one of the foregoing, or an alias representing one of the foregoing.

In another aspect, the invention can feature the at least one connection, if any, made by the web address being a URL name, a path name of a URL, a resource named by a URL, a domain name of a URL, or a subdomain of a URL. The identity can be an owner name, a URL name, a path name of a URL, a resource named by a URL, a domain name of a URL, a subdomain of a URL, a derivative of one of the foregoing, or an alias representing one of the foregoing

In another aspect, the invention can feature the connection tracking process verifying the authenticity of the at least one connection made by the open web address. The system further includes at least one trusted computing device to identify at least authentic one open connection of the open web address. The at least one trusted computing device reports an authenticity list that includes at least one connection of the web address that is authentic.

In another aspect, the invention can feature a connection analysis engine to statistically analyze the connections reported by multiple computing devices that access the same open web address to verify that the at least one connection is a trusted connection that the connection analysis engine assigns a trusted status or is not a trusted connection that the connection analysis engine assigns a distrusted status.

In another aspect, the invention can feature the connection analysis engine being operated on the computing device or on a different computing device that is communicatively connected to the computing device.

In another aspect, the invention can feature the firewall being configured to intercept and automatically block data packets sent to or from the browser software application that are not being sent to or from the open web address or to or from the at least one connection of the open web address.

In another aspect, the invention can feature a reputation engine to allow or block the open web address. The firewall blocks the open web address if the open web address does not meet a reputation threshold as determined by the reputation engine.

In another aspect, the invention can feature a reputation engine to allow or block the at least one connection made by the open web address. The firewall blocks the at least one connection made by the open web address if the at least one connection made by the open web address does not meet a reputation threshold as determined by the reputation engine.

In another aspect, the invention can feature a reputation engine to allow or block at least one other connection to the browser software application. The firewall blocks the at least one other connection if the at least one other connection does not meet a reputation threshold as determined by the reputation engine. The at least one other connection includes one or more connections that are not the open web address or the at least one connection to the open web address.

In another aspect, the invention can feature a web address identity interface to display the identity of the open web address to a user, wherein the web address identity interface comprises at least one control element that permits the user to allow or block data packets sent to and from the open web address by selecting an allowed status or a blocked status for the open web address. The at least one connection, if any, of the open web address is also assigned the blocked status when the user operates the at least one control element of the web address identity interface to block the open web address. The firewall blocks data packets sent to and from the at least one connection, if any.

In another aspect, the invention can feature the at least one connection of the open web address being allowed, and not blocked, when the open web address is blocked but a second open web address that is allowed shares the same at least one connection.

In another aspect, the invention can feature a connection interface that displays the at least one connection of the open web address. The connection interface includes at least one control element that permits the user to allow or block the at least one connection. The firewall blocks data packets sent to and from the at least one connection if the blocked status is selected for the at least one connection. The connection interface can be the web address identity interface or a different interface, and the at least one control element of the connection interface can be the at least one control element of the web address identity interface or a different at least one control element.

In another aspect, the invention can feature the interface displaying the identity of the web address of automatically blocked data packets. The blocked status of the web address of the automatically blocked data packets is overridable by at least one option selected from among the group of: (i) the user using the at least one control element of the interface to manually select the allowed status for the web address to override the blocked status of the web address; (ii) an override process overriding the blocked status of the web address by comparison to a whitelist that informs the override process that the data packets are not being sent to or from the open web address or its at least one connection; or (iii) a reputation engine overriding the blocked status of the web address when the data packets are not being sent to or from the open web address or its at least one connection when a reputation threshold is met or exceeded as determined by the reputation engine.

In another aspect, the invention can feature the allowed open web address being a user-opened web address opened by the user. The system further includes an interface to display the identity of the user-opened web address to a user. The at least one connection includes at least one connection to a remote computing device made by the user-opened web address, if any. The interface does not display the at least one connection made by the user-opened web address but does allow data packets sent to or from that at least one connection. The interface displays and the firewall blocks data packets that are not sent to or received from the browser software application by the user-opened web address or its at least one connection.

In another aspect, the invention can feature an override process to override the blocked status of the data packets that are not sent to or received from the browser software application by the user-opened web address or its at least one connection. The override process compares a web address or identity of the blocked data packets to a whitelist that informs the override process that the blocked status of the blocked data packets should be overridden. The override process displays the blocked data packets and changes their blocked status to allowed status if the web address or identity of the blocked data packets is located in the whitelist.

In another aspect, the invention can feature a web traffic analysis system to determine the identity of the open web address, the identity of the at least one connection of the open web address, or the identity of both. The web traffic analysis system includes a browser plugin, a local man-in-the-middle http/https interception, a remote man-in-the-middle http/https interception, or a web proxy.

In another aspect, the invention can feature an automated health monitor engine that periodically checks a status of a kernel driver of the system to ensure that the kernel driver is operational.

In another aspect, the invention can feature the automated health monitor engine generating an alert if the kernel driver is disabled.

In another aspect, the invention can feature an interface having a continuously changing visual display. A continuous change in appearance of the continuously changing visual display represents that the automated health monitor engine is checking the kernel driver. The continuously changing visual display ceases continuously changing in appearance if the automated health monitor engine is unable to perform the check of the status of the kernel driver.

The invention also features a system for detecting and blocking Trojan malware and other malware as follows: The system includes a computing device that is communicatively connected to a communications network, and a browser software application being operated on the computing device. The system also includes a remote web proxy that replaces at least one connection made by an open web address, if any, with an alias based on a domain name of the web proxy or another domain name. The system further includes a firewall that blocks all data packets not sent to or received from the web proxy by the browser software application. The web address is an open web address if it is open in the web proxy.

In another aspect, the invention can feature the web proxy reporting the open web address to the firewall.

In another aspect, the invention can feature a firewall interface displaying the open web address.

In another aspect, the invention can feature the firewall interface permitting a user to select an allowed status or a blocked status for the web address. The firewall communicates the web address to the web proxy when a blocked status is selected for the web address. The web proxy subsequently blocks data packets sent to or received from the web address and the web proxy blocks the connections made by the web address, if any.

In another aspect, the invention can feature data packets not sent to or received from the web proxy by the browser software application are initially automatically blocked except data packets sent to or received from the browser software application by a web address or IP address that appears on a whitelist.

The invention also features a system for detecting and blocking Trojan malware and other malware as follows: The system includes a computing device that is communicatively connected to a communications network, and at least one non-browser software application operated on the computing device. The system also includes a maker identification process to identify a maker of the at least one non-browser software application. The system further includes an identity verification process to determine an owner of at least one remote host address sending data packets to or receiving data packets from each at least one non-browser software application. The owners of each at least one remote host address, as determined by the identity verification process and the maker of each at least one non-browser software application, are compared to determine whether they are the same or different. The system also includes a firewall to block data packets sent to and from the at least one non-browser software application by each at least one remote host address when the owner of each at least one remote host address and the maker of each at least one non-browser software application are different.

In another aspect, the invention can feature a mismatched application/remote host address communication pair being one at least one remote host address having an owner that is different from the maker of one at least one non-browser software application. The identification of a mismatched application/remote host address communication pair results in the firewall blocking data packets transmitted between the mismatched application/remote host address pair.

In another aspect, the invention can feature a reputation engine that initially blocks data packets from the at least one remote host address when a reputation of the at least one remote host address is determined by the reputation engine to not meet or exceed a reputation threshold.

In another aspect, the invention can feature the system having a first interface to display a name of each at least one non-browser software application, the maker of each at least one non-browser software application, each at least one remote host address with which each at least one non-browser application attempts to communicate, and the owner of each at least one remote host address. The system can also include a second interface that permits a user to selectively allow or block traffic sent to and received from each at least one non-browser software application by each at least one remote host address. The second interface can be the first interface or a different interface.

In another aspect, the invention can feature each non-browser software application of the at least one non-browser software application that communicating with a remote host address of the at least one web address is an application/remote host address communication pair. The system includes a process to initially block all application/remote host address communication pairs. The system further includes a first interface to display a name of each non-browser software application, the maker of each non-browser software application, each web address with which each non-browser software application communicates, and the owner of each such web address. The system can also include a second interface that permits a user to selectively allow or block traffic sent to and received from each at least one non-browser software application by each at least one web address. The second interface is the first interface or a different interface.

In another aspect, the invention can feature each non-browser software application of the at least one non-browser software application that communicating with a remote host address of the at least one remote host address is an application/remote host address communication pair. The system includes a process to initially block traffic between all application/remote host address communication pairs for a temporary period of time. The system further includes a first interface to display a name of each non-browser software application, the maker of each non-browser software application, each remote host address with which each non-browser software application communicates, and the owner of each such remote host address. The system further includes a second interface that permits a user to selectively quarantine one or more application/remote host address communication pairs of all of the application/remote host address communication pairs prior to expiration of the temporary period of time. The second interface can be the first interface or a different interface.

In another aspect, the invention can feature legitimate DNS data packets and local packets and traffic to digital certificate authorities being automatically allowed.

The invention also features a system for detecting and blocking Trojan malware and other malware as follows: The system includes a computing device that is communicatively connected to a communications network, and at least one non-browser software application operated on the computing device. The system also includes an identity verification process to determine an owner of at least one remote host address sending data packets to or receiving data packets from each at least one non-browser software application. The owner of each at least one remote host address as determined by the identity verification process and the maker of each at least one non-browser software application can be compared to determine whether they are the same or different. The system further includes an interface to communicate both an identity of the at least one non-browser software application and the owner of the at least one remote host address with which the at least one non-browser software application is communicating. The system further includes a firewall to block data packets transmitted between at least one application/destination pair, wherein the at least one application/destination pair includes one of the at least one non-browser applications communicating with one of the at least one remote host addresses that is the destination of the at least one application/destination pair.

In another aspect, the invention can feature an interface to permit a user to selectively allow or block one or more of the at least one application/destination pairs.

In another aspect, the invention can feature the firewall automatically blocking communication between each newly encountered application/destination pair of the at least one application/destination pair. The interface permits the user to toggle a current status of each at least one application/destination pair between an allowed status and a blocked status.

In another aspect, the invention can feature the firewall automatically blocking communication between each newly encountered application/destination pair of the at least one application/destination pair unless the newly encountered application/destination pair, the destination, or both are whitelisted. The interface permits the user to toggle a current status of each at least one application/destination pair between an allowed status and a blocked status.

In another aspect, the invention can feature the firewall automatically blocking communication between each newly encountered application/destination pair of the at least one application/destination pair unless a destination reputation of the destination meets or exceeds a destination reputation threshold. The system further includes a destination reputation engine to determine the destination reputation of the destination. The interface permits the user to toggle a current status of each at least one application/destination pair between an allowed status and a blocked status.

The invention also features a system for preventing exposure to Trojan malware and other malware by preventing a connection to a phishing site. The system includes a computing device that is communicatively connected to a communications network and a software application being operated on the computing device. The software application provides content and a link to a site, and is capable of allowing the link to the site to be selected so that the computing device connects to the site. The system also includes an owner identification process to communicate an identity of an owner of the site, and a device for providing a communication of the identity of the owner of the site to a user.

In another aspect, the invention can feature the link being or including a URL name, a path name of a URL, a domain name of a URL, or a subdomain of a URL.

In another aspect, the invention can feature the identity being or including an owner name, a URL name, a path name of a URL, a domain name of a URL, a subdomain of a URL, a derivative of one of the foregoing, or an alias representing one of the foregoing.

In another aspect, the invention can feature the device for providing the communication of the identity of the owner of the site being or including a display device. The communication can include a visual representation of the identity of the owner of the site that is displayed on the display device.

In another aspect, the invention can feature the device for providing the communication of the identity of the owner of the site being or including an audio device. The communication can include an audible representation of the identity of the owner of the site that is played by the audio device.

In another aspect, the invention can feature the system further including a wireless or a wired communicative connection between the computing device and the device for providing the communication of the identity of the owner of the site.

In another aspect, the invention can feature the device for providing a communication of the identity of the owner of the site being a component of the computing device.

In another aspect, the invention can feature the content providing or including context that is deducible by the user.

In another aspect, the invention can feature the system further including an input device for selecting the link to connect to the site.

In another aspect, the invention can feature the content being or including text or images displayed on a web page or in an email, text message, instant message, or another electronic message, from which context is determinable by the user.

In another aspect, the invention can feature the system further including an owner display process for automatically displaying the identity of the owner of the site when an input device moves over or near to the link.

The invention also features a system for preventing exposure to Trojan malware and other malware by preventing a connection to a phishing site. The system includes a computing device that is communicatively connected to a communications network and a software application being operated on the computing device. The software application provides content and a link to a site, and is capable of allowing the link to the site to be selected so that the computing device connects to the site. The system also includes an owner-identity deduction system for deducing an identity of an expected owner of the site, an owner identification process to communicate the identity deduced by the owner-identity deduction system, and a device for providing a communication of the identity of the owner of the site to a user. The system further includes a connection process for allowing the computing device to connect to the site if the identity of the expected owner matches a context of the content and for blocking the computing device from connecting to the site if the identity of the expected owner does not match the context of the content.

In another aspect, the invention can feature the link being or including a URL name, a path name of a URL, a domain name of a URL, or a subdomain of a URL.

In another aspect, the invention can feature the identity being or including an owner name, a URL name, a path name of a URL, a domain name of a URL, a subdomain of a URL, a derivative of one of the foregoing, or an alias representing one of the foregoing.

In another aspect, the invention can feature the device for providing the communication of the identity of the owner of the site being or including a display device. The communication can include a visual representation of the identity of the owner of the site that is displayed on the display device.

In another aspect, the invention can feature the device for providing the communication of the identity of the owner of the site being or including an audio device. The communication can include an audible representation of the identity of the owner of the site that is played by the audio device.

In another aspect, the invention can feature the system further including a wireless or a wired communicative connection between the computing device and the device for providing the communication of the identity of the owner of the site.

In another aspect, the invention can feature the device for providing a communication of the identity of the owner of the site being a component of the computing device.

In another aspect, the invention can feature the content providing context that is deducible by the user.

In another aspect, the invention can feature the system further including an input device for selecting the link to connect to the site.

In another aspect, the invention can feature the content being or including text or images displayed on a web page or in an email, text message, instant message, or another electronic message, from which context is determinable by the user.

In another aspect, the invention can feature the system further including a mismatch reporting process for reporting to a service provider a link or content in which the site does not match the context of the content.

The system also features a method for preventing exposure to Trojan malware and other malware by preventing a connection to a phishing site. The method includes the step of: (a) providing a system including: (i) a computing device including a processor and an associated memory, wherein the computing device is communicatively connected to a communications network; and (ii) a software application being operated on the computing device, wherein the software application provides content and a link to a site, and wherein the software application is capable of allowing the link to the site to be selected so that the computing device connects to the site. The method further includes the steps of: (b) communicating an identity of an owner of the site using an owner identification process and a device for providing a communication of the identity of the owner of the site, wherein if the identity of the owner of the site does not match a context of the content, the site is deemed potentially to be a phishing site.

Another method of the invention can include the step of: (c) connecting or not connecting the computing device to the site based on a comparison by the user of the identity of the owner of the site to the context of the content.

Another method of the invention can include the step of: (d) allowing the computing device to automatically connect to the site if the identity of the owner matches a context of the content and automatically blocking the computing device from connecting to the site if the identity of the expected owner does not match the context of the content.

Another method of the invention can include step (b) of the method further including the step of: (e) automatically displaying the identity of the owner of the site when an input device moves over or near to the link.

Another method of the invention can include the step of: (f) sending a report of any potential phishing site to a service provider.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a flow chart showing a process of the system for processing data packets.

FIG. 2 is a flow chart showing one embodiment of a system for processing data packets sent and received by a browser app.

FIG. 3 is a flow chart showing one embodiment of a system for processing data packets sent and received by a non-browser app.

FIG. 4 is a flow chart showing another embodiment of a system for processing data packets data packets sent and received by a browser app.

FIG. 5 is a flow chart showing still another embodiment of a system for processing data packets data packets sent and received by a browser app.

FIG. 6 is a flow chart showing another embodiment of a system for processing data packets data packets sent and received by a non-browser app.

FIG. 7 is a flow chart showing still another embodiment of a system for processing data packets data packets sent and received by a non-browser app.

FIG. 8 is a graphic representation of the principles that allow the system to operate effectively.

FIG. 9 is a schematic diagram of one embodiment of the system.

FIG. 10 is a schematic diagram of one embodiment of a system for displaying a site's owner even before the user's computer connects to the site, so that any mismatch between owner and context can be identified before the site has an opportunity to infect the user's computer.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a novel system and method that both exposes and blocks persistent malware—finally providing genuinely effective protection against this now most prevalent form of hacking. Trojans are but one example of persistent malware that communicates with a hacker's command and control center; other types of persistent malware exist as will be understood by one of skill in the field. As used herein, the terms “computer” and “computing device” mean a computer, a tablet computer, a server, a mobile device (e.g., a cellular telephone, smartphone, etc.), a gaming device, a smart appliance, a smart television, a smart light bulb, a smart outlet adapter, a smart automobile, and any other device that includes a processor and is communicatively connected to a communications network. The term “smart” used with several items in the foregoing list means that such items are electronic devices that have a wireless connection to a communications network. For purposes of convenience, the term “computing device” is used most frequently herein. In most but not all instances, the computing device also includes at least one browser software application, at least one non-browser software application, or both. Such software applications can be installed locally on the computing device or can be installed on a remote computing device but operated on the local computing device.

The term “web address” used herein means a URL name, a path name of a URL, a domain name of a URL, or a subdomain of a URL. The terms “identity” and “name,” when used alone herein, mean an owner name, a URL name, a path name of a URL, a domain name of a URL, a subdomain of a URL, a derivative of one of the foregoing, or an alias representing one of the foregoing.

The terms related to displaying an owner can refer to displaying the owner's name, and/or a derivative of the owner's name, or any other method of conveying the identity of the owner as is well-known in the art.

The invention features a system for detecting and blocking Trojans and other persistent malware that connect to one or more hackers' command and control centers. The system includes a browser software application installed on a computing device that is communicatively connected to a communications network, a process to communicate an identity or identities of one or more web addresses open in the browser software application, a process that catalogues the connections made by open web addresses, a firewall that intercepts packets to or from a browser and blocks packets that do not belong to an open web address or to any of the connections made by an open web address.

The system can feature automatically blocking a packet if it is to or from a browser yet does not belong to a subdomain of an open web address nor any of the connections made by an open web address. One or more trusted computing devices can record the correct connections made by web addresses so that the connections can be verified before being trusted.

The system can include a process that uses a statistical analysis to deduce the correct connections made by web addresses so that the connections can be verified before being trusted. The system can also include an interface, which displays the names of open web addresses to the user in a manner that permits the user to allow or block the web address. Such names can be the owner of the domain, a domain name, subdomain name, and/or a derivative of these and/or an alias representing any of these. When the user blocks a web address then all of its connections are blocked (unless such a connection is made by a separate, currently allowed web address).

The interface can display the connections opened by web addresses. The interface can display the connections opened by web addresses in a manner that permits the user to allow or deny such connections. The user may elect to allow only data packets that belong to user-opened web addresses or connections made by user-opened web addresses that the user has not denied.

The system can also include a reputation engine that can be used to initially allow or deny a web address (and its subsequent connections), such that web addresses that do not meet an established reputation threshold are initially blocked rather than initially allowed. In another embodiment, the reputation engine can be used to initially allow or deny a web address (and its subsequent connections), such that domains and/or subdomains that do not meet an established reputation threshold are initially blocked rather than initially allowed.

The aforementioned interface (or a different interface of the system) can display the names of automatically blocked packets. Such names can be a name of the owner of the domain, a domain name, subdomain name, and/or a derivative of these and/or an alias representing any of these. In another embodiment, the interface can display the names of automatically blocked packets in a manner that permits the user to override the blocked name. As with the prior embodiment, such names can be the owner of the domain, a domain name, subdomain name, and/or a derivative of these and/or an alias representing any of these.

In another embodiment, the system can feature a whitelist that can override the automatic blocking of browser-based packets that neither belong to an open web address nor to any of the connections made by open web addresses.

The reputation engine of the system may also be capable of overriding the automatic blocking of browser-based packets that neither belong to an open web address nor to any of the connections made by open web addresses if the reputation meets or exceeds an established threshold.

The system may display and allow the names of user-opened web addresses while not displaying, yet allowing, data packets belonging to connections made by user-opened web addresses. In this embodiment, the system may display and block the names of packets that do not meet the prior two conditions.

In another embodiment, the system may display and allow the names of user-opened web addresses while not displaying, yet allowing, data packets belonging to connections made by user-opened web addresses. The names of web addresses sending and receiving data packets that do not meet the prior two conditions may be displayed and blocked unless such packets are whitelisted in which case they are displayed and allowed.

The system can also feature an automated health monitor engine that periodically checks the status of the kernel driver to ensure that the kernel driver is operational. The automated health monitor engine can generate an alert if the kernel driver is disabled. The alert can be visual, audible, or both. In an exemplary embodiment, the automated health monitor engine can include an interface with a constantly changing visual display representing the health monitor checking of the kernel driver such that the display will cease constantly changing if the user interface is prevented from performing the kernel driver health monitoring, thereby alerting the user that the system and computing device have potentially been hacked.

The system can include a browser plugin, man-in-the-middle http/https interception (local and/or remote), and/or a web proxy for determining the identity of open web addresses and of connections made by open web addresses.

The invention also features a system for detecting and blocking Trojans and other malware that communicate with one or more hackers' command and control centers. The system includes a browser software application installed on a computing device that is communicatively connected to a communications network and a remote web proxy, which replaces the connections made by web addresses with aliases based on the domain of the web proxy or some other agreed upon domain. The system also includes a local firewall that blocks all browser-based packets not destined to or received from the web proxy. The web proxy can report the open web address to the firewall, and a firewall interface can display the open web addresses.

The firewall interface can permit the user to allow or deny the web addresses. The local firewall communicates denied web addresses to the web proxy, and the web proxy subsequently blocks the affected web addresses and their connections.

The system may initially block data packets that are not destined to or received from the web proxy except whitelisted subdomains, domains, domain owners, and/or IP addresses (which are allowed).

In one example, a web proxy could be used for browser traffic in which the web proxy communicates the web addresses of one or more open web addresses to the firewall of the system, and the web proxy could replace the connections made by the open web addresses with aliases such that the firewall could automatically block data packets if they do not belong to the subdomain and/or domain of any open web address.

The invention also features a system for detecting and blocking Trojans and other malware that connect to one or more hackers' command and control centers, wherein the system includes a non-browser software application installed on a computing device that is communicatively connected to a communications network, a process that communicates the owner of the domains of the data packets sent to or from the non-browser app, a process to communicate the maker of the non-browser app, and a process that initially blocks packets when the identity of the maker of the app does not match the identity of the owner of the data packet's domain.

This system can include a reputation engine in which packets are only initially blocked if the maker of the app does not match the owner of the domain, or if the reputation of the domain and/or the domain owner does not meet or exceed an established reputation threshold.

This system can also feature an interface that displays the app names and/or the names of apps' makers, and the owner of the remote domains with which each app attempts to communicate. The system can also include an interface (which may the same interface as the previously described one or a different interface) that permits the user to selectively allow or deny traffic to and from each app on a per domain and/or per domain owner basis.

The system can include a process that initially blocks all app/domain communication pairs, i.e., non-browser software applications and remote host addresses (also referred to herein as “destinations”) that communicate or attempt to communicate with one another. An interface of the system can display the app names and/or the names of their makers, and the owner of the remote domains with which they attempt to communicate. The system may include a second interface that permits the user to selectively allow traffic to and from each app on a per domain and/or per domain owner basis, or these steps may be completed using the first interface.

The system can further include a process that initially blocks all app/domain communication pairs for a temporary period of time and an interface that displays the app names and/or the names of their makers, and the owner of the remote domains with which they attempt to communicate. Either that first interface or a second interface may be provided by the system to permit the user to selectively quarantine the app/domain pairs before the time expires for the temporary period of time (in which case, the app/domain pair is allowed if not quarantined before the time expires).

The system may automatically allow legitimate DNS packets, traffic to digital certificate authorities, and legitimate local packets.

As previously detailed in prior disclosures, a user can control who can access the user's computing device when the user views the names of every party who wants to talk, in near real-time, each time the named entity wants to talk (i.e., communicate), whether that named entity is currently allowed or not. Entities can be any of the following (or derivatives or aliases of the following):

IP addresses

Subdomains (e.g., a.2mdn.net, b.2mdn.net, y.gstatic.com, and z.gstatic.com)

Domains, also referred to herein as Domain Names (e.g., 2mdn.net, and gstatic.net)

Registered Owners (e.g., “Google Inc.”)

We shall refer to the following as “Entity Hierarchy”: IP Addresses→Subdomains→Domains→Registered Owners. Each level of the Entity Hierarchy moving from left to right encompasses more data packets. A single Registered Owner name can encompass hundreds of Domains, thousands of Subdomains, and even tens of thousands IP Addresses. Thus, when displaying the identity of the entity who wants to communicate with the computing device, some embodiments may choose to use Domain Names and/or Registered Owner names to reduce the amount of information a user will need to see in order to make an informed choice over who can access the computing device and who cannot.

Two broad categories of PC internet traffic exist: browser data packets sent to or from a browser software application and non-browser data packets sent to or from non-browser software applications. For non-browser traffic, the user may find it useful to choose the app/destination pair. For example, a user may want to allow WinWord to talk to Registered Owner Microsoft Corp.; yet the same user might want to block WinWord from talking to Registered Owner Richard Smith.

Allowing the user to allow or block an app/destination pair provides genuinely effective protection against the real-world problem of Trojans (also known as Trojan horse malware) injecting themselves into legitimate apps. For example, Richard Smith is the owner of xyz.org. If a Trojan injects itself into WinWord and tries to send sensitive data to trojan.xyz.org, one embodiment could show the user that WinWord wants to talk to Richard Smith. By keeping this connection blocked, yet allowing WinWord to talk to Microsoft Corp., the user's sensitive information remains protected while WinWord's legitimate activity remains intact.

Thus, a highly effective method for protecting non-browser apps is to display the name of the app (or a derivative of the name or an alias representing the name) along with the destination name at the time the app wants to communicate with the non-browser app. Moreover, the most secure method would be to initially block each new app/destination pair unless the pair was specifically whitelisted and/or the user chooses to unblock the communication between the pair. In addition to or alternative to displaying the app name would be to display the name of the maker of the app. For example, some embodiments might display that “Microsoft Corp.'s Winword” wants to talk to “Microsoft Corp.”

Another highly secure method would be to temporarily block each newly encountered app/destination pair (unless the pair is whitelisted), and to display the requested connection to the user. If the user takes no action, then the app/destination pair status automatically changes to allowed. However, if the user takes action then the status changes from “temporarily blocked” to “permanently blocked” (i.e., blocked until the user specifically decides to allow it and/or the app/destination pair is later added to a whitelist).

A Trojan can literally send millions of bits of data in a single second. Therefore, the initial blocking of the Trojan is important so that not a single bit of data is compromised. On the other hand, some users may not want to have to manually allow every individual app/destination pair. By temporarily blocking all newly encountered app/destination pairs, both objectives can be satisfied for such users, and therefore, some embodiments may implement this particular method.

Showing the name to whom each app wants to talk offers convenient security for non-browser apps since the vast majority of such apps typically talk to a single company, organization, or person. In other words, the vast majority of such non-browser apps typically talk to a single Registered Owner name—usually the name of the maker of the app itself (with notable exceptions being communication with DNS Servers and/or digital certificate authorities). This property of non-browser apps lends itself to a novel form of rule-based whitelisting: if an app wants to talk to its maker and/or a DNS Server and/or a digital certificate authority, then allow it to do so. This rule is hereafter referred to as Maker-Based Whitelisting. This Maker-Based Whitelisting method elegantly protects the vast majority of non-browser apps when they are hijacked for nefarious hacking purposes.

In stark contrast to non-browser apps, the vast majority of browser traffic is to destinations other than the browser's maker. For example, the vast majority of Firefox traffic is to destinations other than Mozilla (the maker of Firefox). To complicate matters even more, when a user enters in a single URL (e.g. “cnn.com”), that webpage can connect the user to numerous other sites. For example, on Jan. 20, 2017, cnn.com automatically connected users to 56 other sites. Thus, when a Trojan hijacks a browser, the Trojan can easily hide its connection to the command and control center inside of such lists. Most users cannot decide which of the 56 seemingly random connections are legitimate and which one is a Trojan talking to a command and control node.

Therefore, with browsers, even using Registered Owner names (as opposed to domain and subdomains) does not reduce the traffic enough for the average user to spot a Trojan. The previously stated non-browser app whitelisting rule (Maker-Based Whitelisting) does not help either. Browser traffic requires a different approach.

To significantly reduce displayed browser traffic names, traffic can be managed by the following Group Policy: if the user approves a URL (or the URL is whitelisted) then allow all connections made by that URL for as long as its webpage is active in the browser, without displaying such connections. For example, if cnn.com is an allowed URL then automatically allow the 56 sites to which it connects without displaying the 56 sites.

Some embodiments of the system that can accomplish the above include (but are not limited to) a browser plugin that transmits each open URL and their connections to the security system, a local man-in-the-middle http/https interception can be used to retrieve this information, and/or a remote man-in-the-middle http/https proxy can be used to obtain open web addresses and their respective connections.

With the Group Policy, the user would see “cnn.com”—not 57 entity names (i.e., “cnn.com” plus the other 56 sites to which it connects), or even more domain/subdomains. If the user allows cnn.com, then all of cnn.com's connections can be allowed as well.

In some embodiments, a browser plugin can display the connections on the webpages themselves. For example, the main security display of the system would solely show cnn.com while the plugin could show the 56 connections on the cnn.com browser webpage itself. Such embodiments could also give the user the ability to block any and/or all of the URL's connections. Some embodiments might allow the user to see the connections from a Menu choice in the main program and/or control the individual connections from a Menu choice in the browser plugin as well.

With the Group Policy, Trojans are now easily exposed and blocked when they hijack the browser. For example, if a Trojan trying to connect to trojan.xyz.org hijacks Firefox while the user is accessing cnn.com, under the Group Policy, the user would see that Firefox wants to connect to two entities: Turner Broadcasting (the registered owner of cnn.com) and Richard Smith (the registered owner of xyz.org). The user can now easily allow the cnn.com connection while keeping the Trojan connection blocked.

The Group Policy can also be used for automation: Automatically allow open web addresses and their connections while automatically blocking everything else. In the example above, cnn.com and its connections would automatically be allowed while Trojan.xyz.org would be automatically blocked (since it is neither an open URL subdomain nor the subdomain of any connection made by an open URL).

The Group Policy easily exposes and blocks Trojans that attempt to make direct connections to their command and control center while masquerading as Firefox. However, an open loophole still remains: the Trojan can inject its command and control center destination into a webpage and thereby cause the connection to be allowed (at least temporarily).

Pages that use pure HTTPS have a degree of protection against such an attack because the HTTPS protocol uses end-to-end encryption to help prevent this very problem. However, many web pages still use HTTP which is unencrypted, and therefore, easily tricked. Also, many HTTPS man-in-the-middle proxies are in use today, which strip the HTTPS encryption protection. Thus, in neither HTTP nor HTTPS can the contents of the webpages be implicitly trusted.

To close this loophole, some embodiments can use Consensus-Based Whitelisting. In this novel method, the connections made by web addresses are recorded by one or more trusted machines (and/or a statistical deduction of the correct connections can be made from sampling a number of user machines for any given URL). When a user's computing device wants to connect to a URL, the correct connections can be retrieved from the internet via an encrypted connection. These consensus-based connections are then used for the Group Policy (as opposed to inherently trusting the connections listed in the local webpage).

For example, if a Trojan successfully inserts trojan.xyz.org into the local cnn.com webpage (in an effort to get the security system to allow traffic to and from trojan.duckdns.org), under Consensus-Based Whitelisting, the user's computing device will download the 56 correct connections and these alone are used for the Group Policy. Thus, when Firefox seeks to connect to trojan.xyz.org, the user will see both Turner Broadcasting and Richard Smith as the two requested connections (since trojan.xyz.org was not included in the Consensus-Based Whitelisting Group Policy).

Thus, Consensus-Based Whitelisting exposes and blocks Trojans that inject themselves into browsers, regardless of whether they try to make a direct connection or whether they insert their command and control destinations into the local webpages themselves.

An alternative to or adjunct to Consensus-Based Whitelisting is the use of a web proxy for the correct identification of connections made by web addresses. (See below for a description of one embodiment.)

Consensus-Based Whitelisting can also be used for non-browser apps as an adjunct to Maker-Based Whitelisting. As one example, Consensus-Based Whitelisting can be used when an app has legitimate traffic that does not involve its maker. In other words, an app's traffic can be allowed if it passes either the Maker-Based Whitelisting rule or if one or more trusted machines (or a statistically significant number of other machines) record the same app communicating with the same destination (i.e., Consensus-Based Whitelisting).

Some embodiments can use Consensus-Based Whitelisting to automate the discovery of an apps maker.

Remote web proxies can also be used for managing open web addresses and their respective connections. For example, a remote web proxy can report the domain and/or subdomain, and/or path, and/or URL name of each open URL to the firewall. For example, if the user enters “cnn.com” in the web proxy then it can report “cnn.com” as an open URL. The web proxy could also replace connections made by open web addresses with aliases based on the web proxy's domain or some other agreed upon domain. For example, if the web proxy domain is TerraProxy.com and cnn.com connects to “optimizely.com” and “instantads.com” then the web proxy could replace “optimizely.com” with “abc.TerraProxy.com” and the web proxy could replace “instantads.com” with “xyz.TerraProxy.com”. When the local browser seeks to connect to “abc.TerraProxy.com” the web proxy converts this back to “optimizely.com” and when the local browser seeks to communicate with “xyz.TerraProxy.com” the web proxy converts this back to “instantads.com.” This will force all legitimate web browsing to flow through TerraProxy.com. Therefore, the firewall can initially block all web-based traffic that does not flow through the web proxy (e.g. TerraProxy.com). Moreover, the firewall can provide an interface for the user to see and block the list of open web addresses. The firewall reports the blocked web addresses to the web proxy, which in turn shuts down the web address and its respective connections. This will prevent Trojans from secretly using the web proxy for connectivity to a command and control center.

Some embodiments could use a plugin for certain browsers and use the remote web based proxy for other browsers. In other words, the plugin could report open web addresses and manage the connections made by those web addresses for the given browser while the remote web proxy could be used to manage open web addresses and their respective connections for browsers that do not have such plugins available.

The combination of Maker-Based Whitelisting and Consensus-Based Whitelisting (along with Group Policy) provides formidable protection for browser apps and non-browser apps alike. Therefore, a hacker could try to secretly disable the blocking/allowing security in an effort to covertly bypass it. An automated Health Monitor can protect against this remaining attack vector.

Many embodiments will implement the allowing/blocking mechanism as a kernel driver. To determine the health status of the kernel driver, the GUI process can do one or more of the following:

Periodically check the status of the driver;

Periodically poll the driver;

Receive periodic beacons from the driver; and/or

Consider the driver healthy if traffic data is regularly received from the driver.

For example, in one embodiment the GUI queries the driver every four seconds to get the information it needs to construct the display. Each time the driver responds to the query, this particular embodiment changes the color of a circle on the display (continually transitioning it from a grey color to a blue color and back again). If the driver should fail to respond to the query, then the GUI changes the color of the circle to permanent red.

In the example embodiment, if a hacker infects the GUI then the color would cease to change, and if the hacker infects the driver then the color changes to red. Such a health monitor alerts the user to both types of infection, thereby protecting the user from all attack vectors.

A number of ways are available to implement such a health monitor. Provided that the health monitor is implemented such that the GUI continually changes the presentation of the health monitor based upon continued observation of driver state within the confines of a real-time traffic monitor integrated with a real-time traffic controller, such would be in the spirit and scope of this disclosure, as would altering the presentation of the health monitor based upon a change of driver status within the same confines.

Explanation of Figures

The system and method disclosed herein control the physical network interface card (NIC) in a computer 902. The firewall component (901) can be implemented as a kernel driver; and the interface to the display (904) can be a higher-level process or program communicating with the kernel driver.

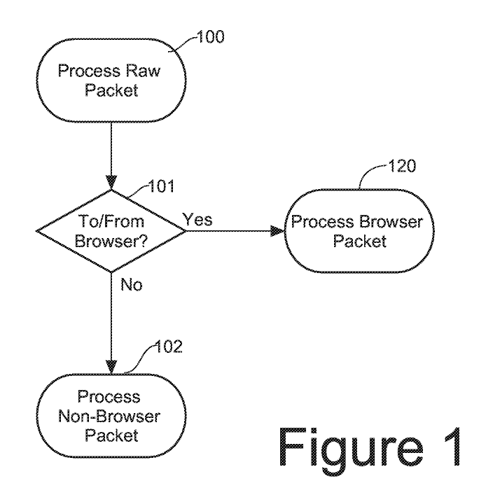

FIGS. 1-3 show one embodiment that can be a standalone Trojan trapping system and/or implemented as a subprocess, which exposes and blocks Trojans within a larger firewall system. This embodiment processes the NIC's raw data packets 100 by dividing Internet-based packets into two categories: browser packets 120 and non-browser packets 102.

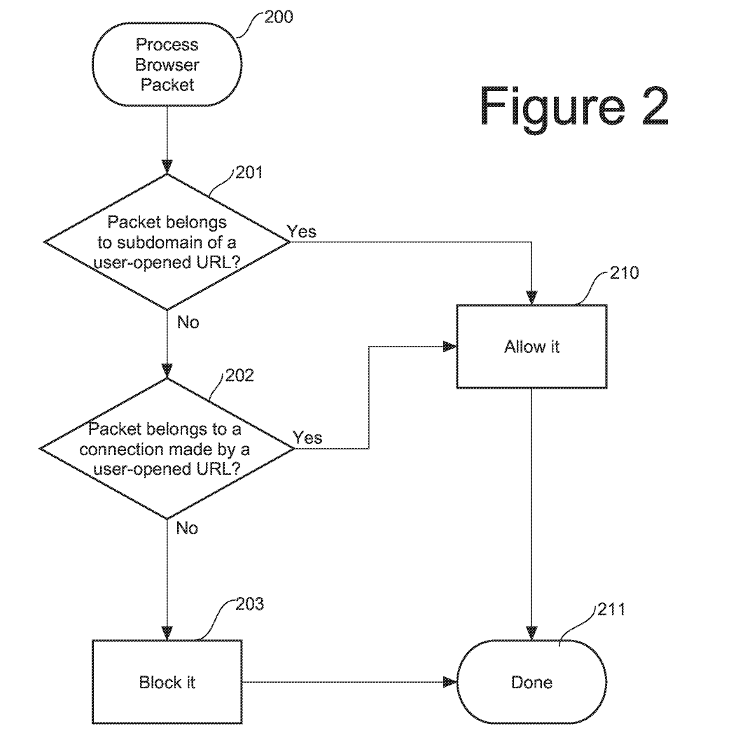

FIG. 2 shows one example embodiment for processing browser packets. This embodiment first checks to see if the packet belongs to the subdomain of an open URL 201. Alternate embodiments might check to see of the packet belongs to the domain instead (e.g., alternate embodiments might approve cnn.com even if the URL itself is the subdomain sports.cnn.com).

If the packet does belong to the subdomain of an open URL 201 then the packet is allowed 210. If the packet does not belong to the subdomain of an open URL 201 then the packet is checked to see if belongs to any of the connections made by an open URL 202.

If the packet does belong to a connection made by an open URL 202 then the packet is allowed 210. If the packet does not belong to a connection made by an open URL 202 then the packet is blocked 203.

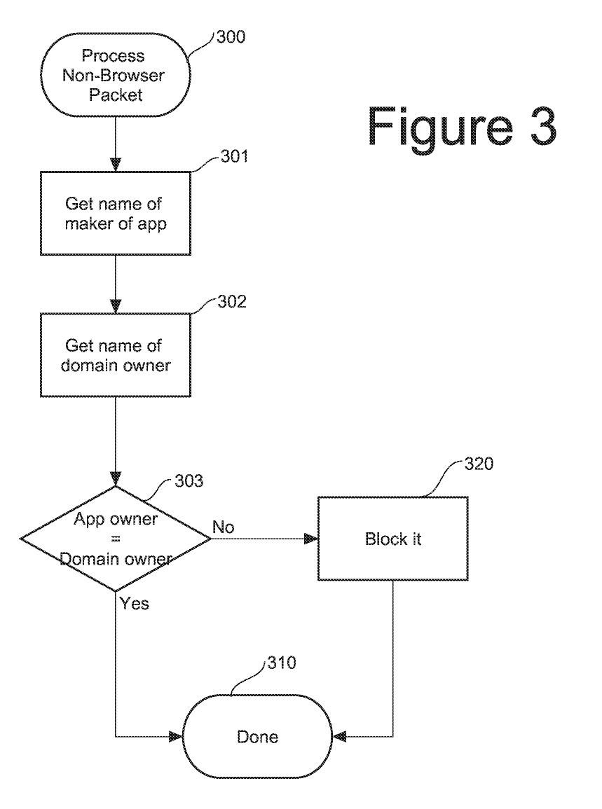

FIG. 3 shows one example embodiment for processing internet-based packets to and from non-browser apps 300. In this particular embodiment, the name of the maker of the app is obtained 301. Most software apps these days are digitally signed. Such digital signatures contain the name of the maker of the app. This is one way of obtaining the name of the maker of the app. There are other methods well known in the art.

The next step in this example embodiment is to obtain the name of the owner of the domain of the remote device to which the app is communicating 302. Various means of obtaining this information include standard Whois lookups and/or proprietary databases (such as those published by numerous third parties).

The next step in this example embodiment is to determine whether the name of the app's maker matches the name of the domain owner 303. If the names do not match 303 then the packet is blocked 320; otherwise, the packet continues forward.

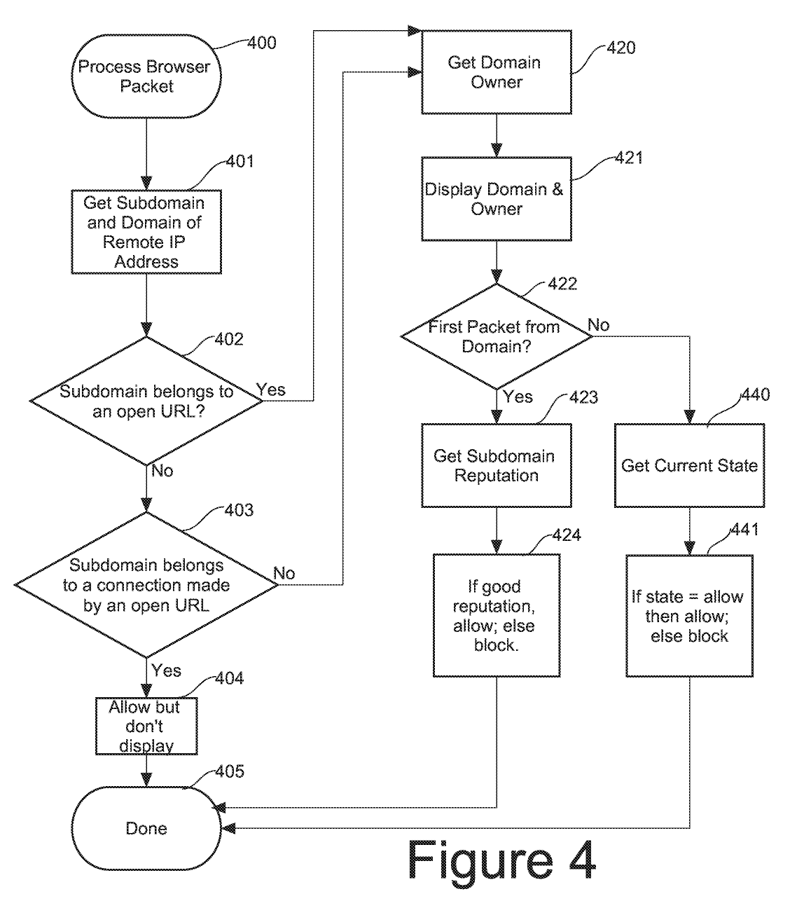

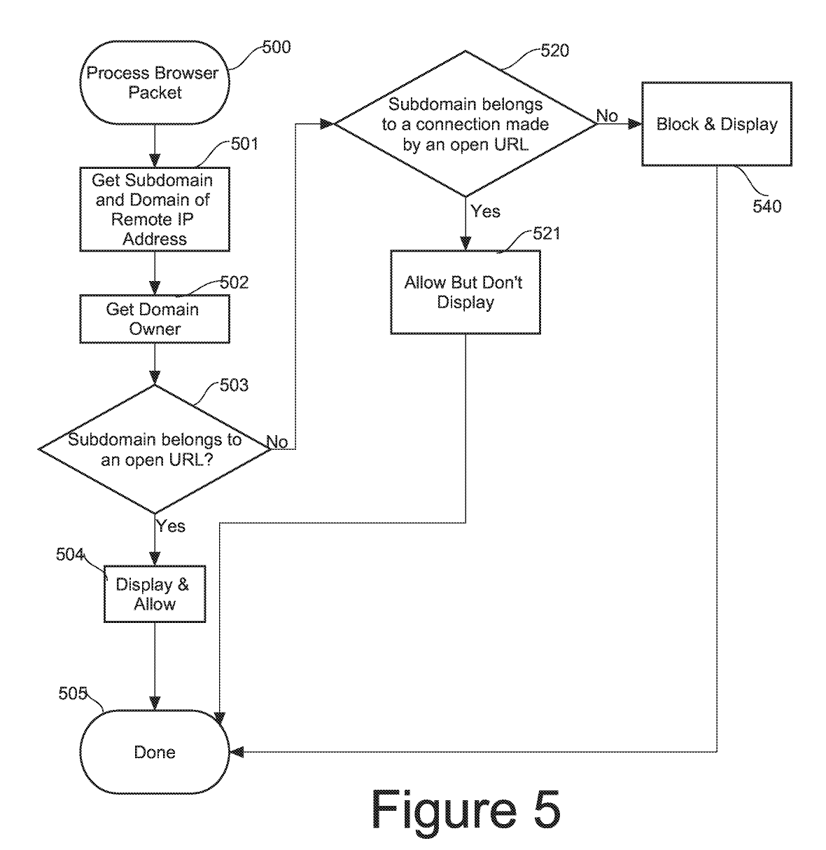

FIGS. 4 and 5 show two additional example embodiments for how browser packets can be processed. There are numerous other possible alternative embodiments. FIG. 4 is an example embodiment where the initial state is based upon the reputation of the web address. The user can then toggle the state thereafter. FIG. 5 is an embodiment that does not use a reputation engine.

In the embodiment shown in FIG. 4, browser packets 400 are processed by first translating the remote IP address into its subdomain and domain 401. For example, an IP address might be translated into subdomain maps.google.com and domain google.com. Methods for mapping IP addresses into domains/subdomains have been disclosed in U.S. Pat. No. 9,467,324. The system next checks to see if the subdomain matches an open URL 402, i.e., a web address that is open within the browser app. A browser plugin can be used to transmit open and closed web addresses. Web addresses can also be obtained from HTTP/HTTPS interception, and/or remote web proxies.

If the subdomain does not match an open URL 402, the system then checks the subdomain to see if it belongs to any of the connections made by an open URL 403, and if it does belong then it is allowed but not displayed 404. The connections made by an open web address can be determined by a browser plugin using standard Web Extensions API calls, or for greater security, the web address connections can be downloaded from a local LAN server or remote WAN server which retrieves the web address connections from one or more trusted machines that accessed the same web address and/or a statistical determination made from multiple user machines that accessed the same web address. Alternatively, or adjunctively accessing web pages via a remote web proxy can allow correct web address connections to be obtained from and/or managed by the remote web proxy.

If the subdomain does not match an open web address and it is not from any connection made by an open web address, then the domain owner name is retrieved 420. The domain owner name can be obtained by a Whois lookup and/or from proprietary database lookups (such as in cases where anonymous domain privacy services are returned in the Whois lookup). The domain name and its respective owner are displayed 421.

The packet is then checked to see if it is the first packet from the domain 422 (or alternatively from the subdomain). If it is the first packet received form the subdomain, then the subdomain's reputation is checked 423 to determine whether to allow or block it 424. If this is not the first packet from the domain/subdomain, then the current state is retrieved 440 in order to determine whether to allow or block it 441.

In the embodiment of the system shown in FIG. 5, browser packets 500 are processed by first translating the remote IP address into its subdomain and domain 501. Then, the owner is retrieved 502. If the subdomain matches an open URL 503 then the owner and domain (and/or subdomain) are displayed and allowed 504.

If the subdomain does not match an open URL 503 then the system of this embodiment checks to see if the subdomain belongs to a connection made by an open URL 520. The same methods discussed above can be used to determine connections made by open web addresses. If the subdomain belongs to a connection made by an open URL 520 then it is allowed but not displayed 521; otherwise, the subdomain is blocked and displayed 540.

FIGS. 4 and 5 both illustrate examples of embodiments of the system in which the connections made by open web addresses can be allowed yet not displayed in order for Trojans that hijack browsers to easily be exposed and blocked. Any Trojan hijacking a browser will be displayed in these embodiments. Meanwhile, the plethora of extraneous web address connections will not be displayed so that the Trojan's presence is readily seen by the user and blocked.

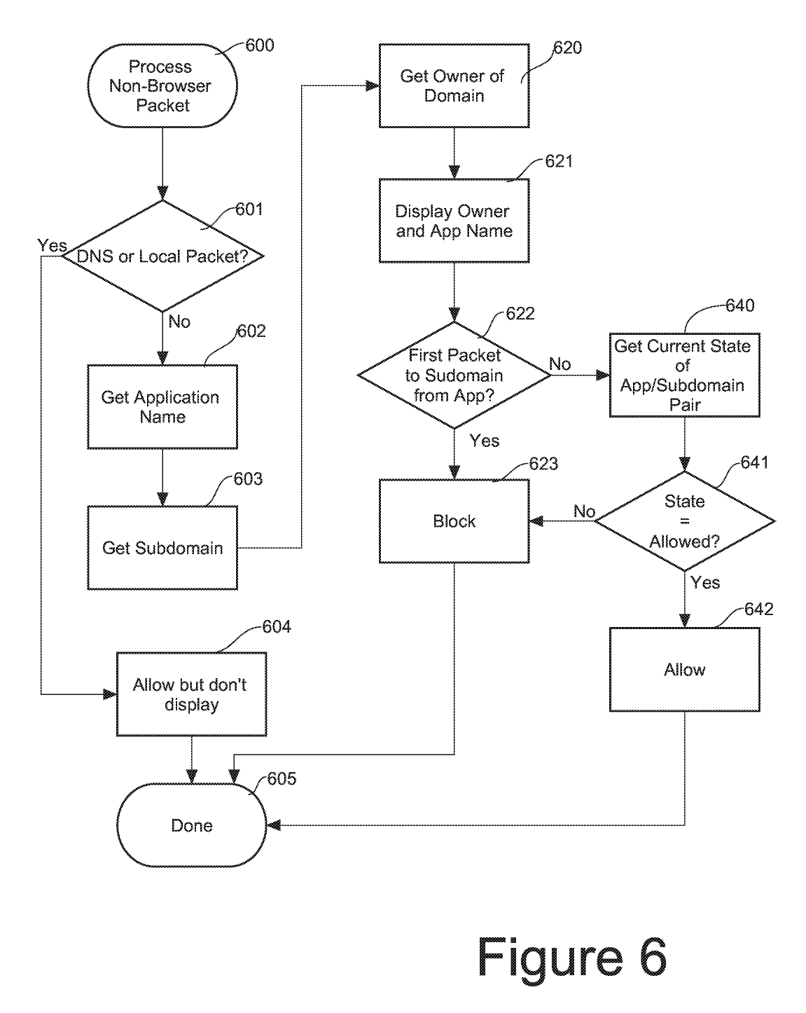

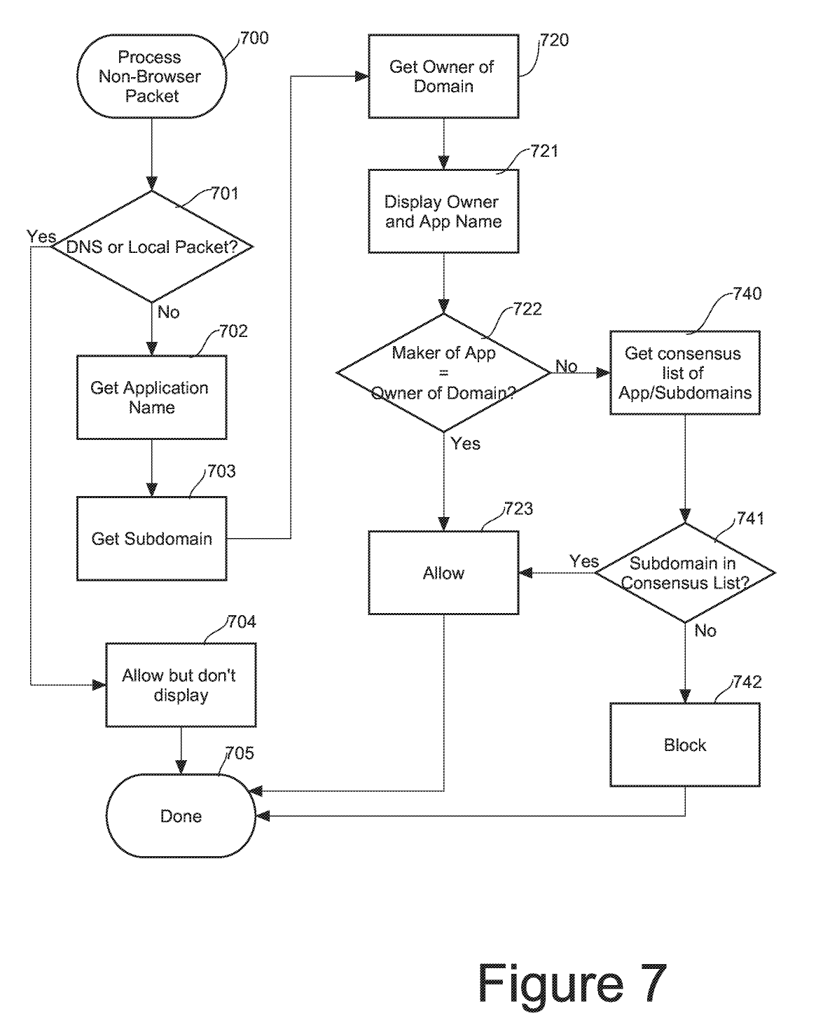

FIGS. 6 and 7 illustrate additional example embodiments for processing non-browser data packets, i.e., data packets sent to and from a non-browser app. Numerous alternative embodiments are possible. The FIG. 6 embodiment illustrates a manual implementation in which every new app/destination pair is initially blocked. The user can then manually toggle the status thereafter. The FIG. 7 embodiment illustrates an automated implementation that uses a combination of Maker-Based Whitelisting and Consensus-Based Whitelisting to determine the initial state of each app/destination pair. The user can then toggle the status thereafter, if the user so chooses.

The FIG. 6 embodiment begins by first examining whether the packet is either a DNS packet or local packet 601. If it is either of these types of data packets, then the packet is allowed but not displayed 604. Alternatively, the DNS packets can be processed in accordance with the methods disclosed in U.S. Pat. No. 9,467,324 for greater security.

If the packet is neither a DNS packet nor a local packet 601 then the name of the application with which it is communicating is retrieved 602. Modern operating systems provide Transport Layer API calls to obtain such information. Next, the IP address of the remote machine is translated into a subdomain 603. Next, the owner of the subdomain is retrieved 620. The app and its owner are then displayed 621.

If this is the first packet from the app/destination pair 622 then the initial status is set to blocked 623. If this is not the first packet from the app/destination pair 622 then the current state is retrieved 640 in case the user previously has manually allowed the pair. If the current state is not allowed 641 then the pair remains blocked 623. If the current state is allowed 641 then the pair remains allowed 642. Note that the manual toggling of states is described in U.S. Pat. No. 9,467,324, which is incorporated herein in its entirety by this reference.

The FIG. 7 embodiment is the same as the FIG. 6 embodiment until the App/Owner Name are displayed 721. Then, at this point, this embodiment uses Consensus-Based whitelisting to determine initial status.

The FIG. 7 embodiment checks to see if the maker of the app matches the domain owner 722. If it does, then the packet is initially allowed 723. If the maker of the app does not match the domain owner 722 then a consensus list of app/destination pairs is retrieved from a local LAN server and/or a remote WAN server 740. If the destination is in the consensus list 741 then the pair is initially allowed 723; otherwise, the pair is initially blocked 742.

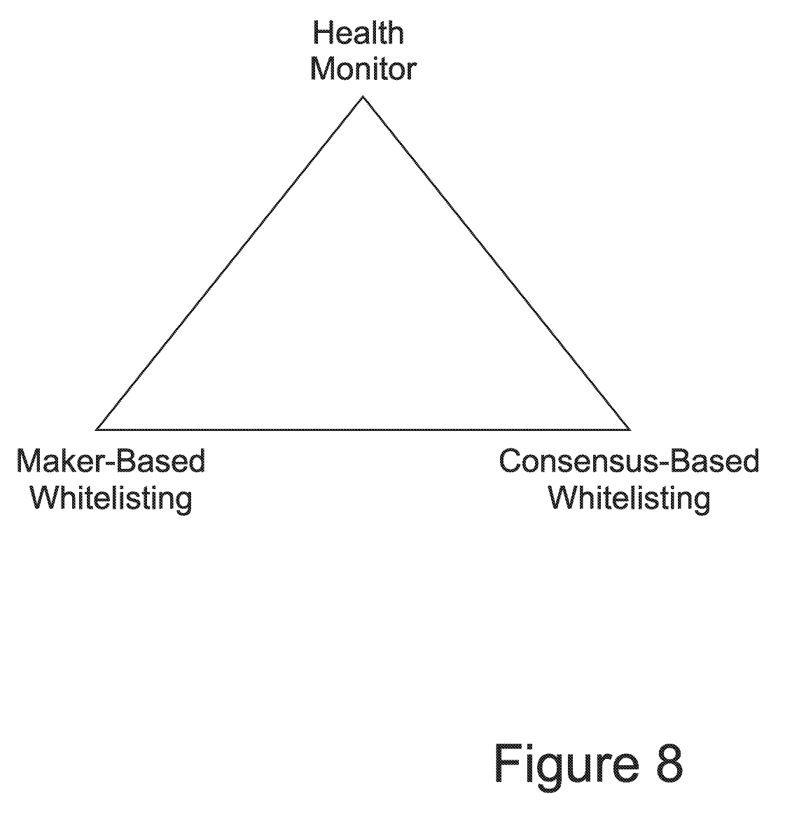

FIG. 8 illustrates an embodiment implementing the tri-level security of Automated Health Monitor, Maker-Based Whitelisting, and Consensus-Based Whitelisting. As long as the Health Monitor is transitioning in color (e.g., grey→blue→grey→repeat), the Maker-Based Whitelisting and Consensus-Based Whitelisting can be trusted. Otherwise, the user is alerted to disconnect from the Internet to keep the computing device contents safe. Any continually changing characteristic (e.g., color, shape, etc.) can be used in the Health Monitor to signify ongoing security.

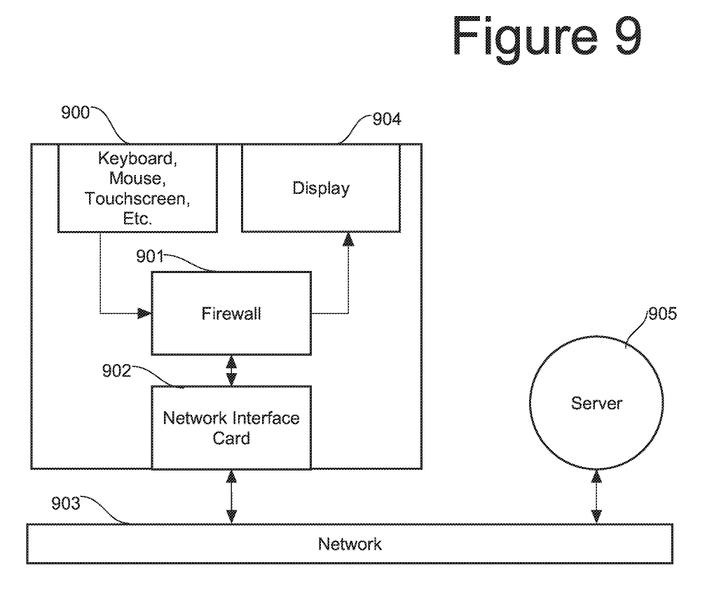

FIG. 9 illustrates the system and method's control of the physical components of a computing device. The user keyboard, mouse, touchscreen, etc., 900 are used to toggle state changes (see U.S. Pat. No. 9,467,324 for alternative embodiment implementations). The firewall itself 901 blocks/allows the data packets of the NIC 902 in accordance with the disclosure contained herein as well as the disclosure contained in U.S. Pat. No. 9,467,324. The server 905 houses the connections made by various web addresses to be retrieved and used for Consensus-Based Whitelisting. The server can also house app/destination pairs for embodiments that use Consensus-Based Whitelisting for non-browser apps.

Systems and Methods for Preventing Connection to a Phishing Site

The invention also features a system for preventing exposure to Trojan malware and other malware by preventing a connection to a phishing site (e.g., a malicious website that includes malware). The system includes a computing device that is communicatively connected to a communications network and a software application being operated on the computing device. The computing device includes a processor and an associated memory. The computing device may include other integral components including, without limitation, one or more of the following components: a user input device, a display (e.g., a display screen or a monitor), a modem, a network interface card, and a speaker. In other embodiments, one or more of the aforementioned components may be separate stand-alone devices that are communicatively connected to the computing device via a wired connection or a wireless connection. In still other embodiments, one or more of the aforementioned components may be components of one or more other separate and distinct devices, wherein such devices are communicatively connected to the computing device via wired connection or a wireless connection.

The input device can be a mouse, a trackball, a touch pad, a touch screen, or any other device that allows the user to provide input that is received by the computing device. In embodiments that include a display, the display can be a touch screen. In other embodiments, the system can include both a display and a separate touch screen device. In some embodiments, the input device is a microphone communicatively connected to a computing device that includes software for receiving a voice command to select a link shown on the display. In one embodiment, the input device used to select the link is a brain-computer interface. In other embodiments, the input device can be a pointing device, keyboard, joystick, gamepad, jog, dial, camera, button, switch, controller, or voice command device. The input device is communicatively connected to the computing device and can be an integral part of the computing device or a separate device that includes a wired connection or a wireless connection to the computing device. The input device is used by the user for, among other things, selecting a link displayed in an email, document, web page, text, instant message, other electronic or digital message, or non-browser software application to connect to a site.

The software application (also referred to elsewhere herein as an “app”) provides content and a link to a site. The software application is capable of allowing the link to the site to be selected (e.g., using input received from the input device) so that the computing device connects to the site. The system also includes an owner identification process to communicate an identity of an owner of the site, and a device for providing a communication of the identity of the owner of the site to a user. The communication provided by the device communicates, visually or audibly to the user, the identity of the owner of one or more sites so that the user can match the owner to the expectation set by the contexts in the content of one or more emails, web pages, text messages, instant messages, other electronic messages, electronic documents (e.g., in a Microsoft Word document or Excel spreadsheet), non-browser software applications. The user can decide whether the owner matches the context of the content.

The link can be or can include a URL name, a path name of a URL, a domain name of a URL, or a subdomain of a URL. A link is any user-actionable entity (for example, one of the items listed above) that directs the computing device to connect to an external location (e.g., to a remote website or to a remote computing device) upon the associated user action (e.g., clicking on or otherwise selecting the link). Examples of links include, but are not limited to, a displayed URL that the user clicks, a displayed image that the user touches on a tablet or phone, a domain name that the user's mouse hovers over, and a selection list of sites from which the user makes a verbal choice via voice recognition software. Any user-actionable entity that directs the computing device to connect to an external location constitutes a “link.”

The identity of the owner of the site, as communicated by the owner identification process, can be or can include an owner name, a URL name, a path name of a URL, a domain name of a URL, a subdomain of a URL, a derivative of one of the foregoing, or an alias representing one of the foregoing.

In exemplary embodiments, the device for providing the communication of the identity of the owner of the site can be or can include a display device. In such embodiments, the communication can include a visual representation of the identity of the owner of the site that is displayed on the display device. For example, the display may display a visual representation that is the name of the owner, a logo or other symbol associated with or useful for identifying the owner of the site to the user, or a color code that is associated with a particular owner and that will be recognized by the user of the system.

In other embodiments, the device for providing the communication of the identity of the owner of the site can be or can include an audio device (e.g., a speaker). In such embodiments, the communication can include an audible representation of the identity of the owner of the site that is played by the audio device. For example, the audio device may play a recording of the spoken name of the owner of the site, or the system may include software for producing a computer-generated audible representation of the owner of the site (e.g., a text-to-speech audible reading of the owner's name).

The system may further include a wireless communicative connection or a wired communicative connection (or both) between the computing device and the device for providing the communication of the identity of the owner of the site. In some embodiments of the system, the device for providing a communication of the identity of the owner of the site can be an integral component of the computing device. In other embodiments of the system, the device for providing a communication of the identity of the owner of the site can be a separate device or a component of a separate device rather than being integrated as a component of the computing device

The content can be or can include text or images displayed on a web page or in an email, text message (e.g., SMS or MMS), instant message, or another electronic message, from which context is determinable by the user. The content provides or includes context that is deducible by the user. For example, if a user receives an email that purports to be from PayPal, then the user would deduce that the email must relate to services offered by PayPal, and thus, that any links within the email should connect to sites owned by PayPal, e.g., paypal.com. Using the system, if the email that purports to be from PayPal but that includes a link that is shown to the user to be owned by “Bad Hacker” or that displays a URL of http://www.phishingsite.com, the user is able to deduce that the email includes a link to a site not owned by PayPal and that no connection should be made to that site. The user would simply refrain from connecting the computing device to that site by not selecting the link in that email. Embodiments of the system function similarly with respect to links displayed on web pages, in documents, and in non-browser software applications. Importantly, a link itself can constitute and provide context. For example, the phrase “Click here to access Bank of America” can be both content that provides context and a clickable user-actionable entity (i.e., a link).

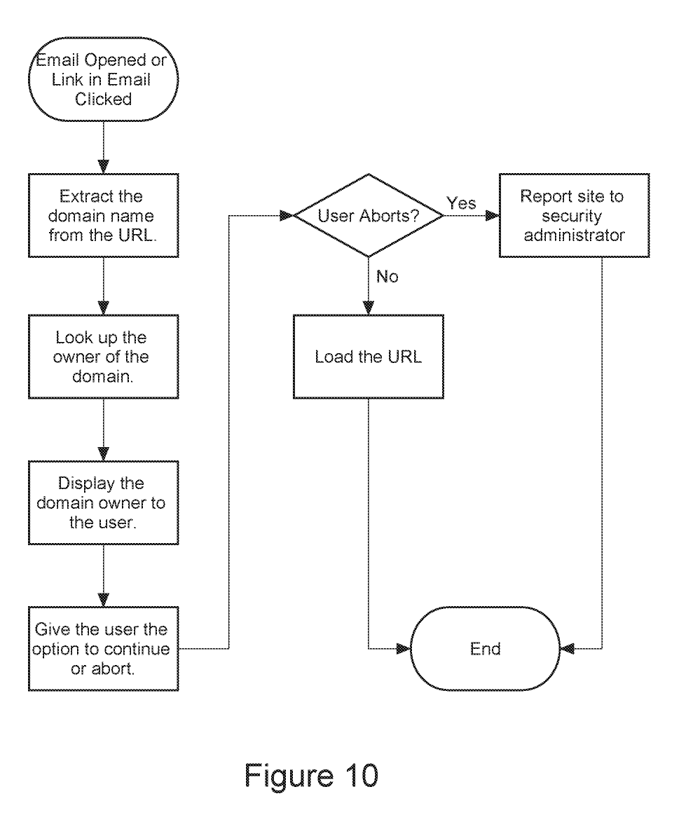

In exemplary embodiments, the system communicates to the user the identity of the site's owner even before the user's computing device connects to the site, so that any mismatch between owner identity and context can be identified before the site has an opportunity to infect the user's computer with malware. FIG. 10 illustrates one example of an embodiment of the system that includes this feature.

The system can also include an owner display process for automatically displaying the identity of the owner of the site when an input device moves over or near to the link.

In exemplary embodiments of the system, the system also includes an owner-identity deduction system for deducing an identity of an expected owner of the site. The owner-identity deduction system may include software, hardware, or both that are components of or installed on the computing device or that are components of or installed on a different device (e.g., a second computing device). For example, the owner-identity deduction system can use artificial intelligence to deduce an expected owner and alert the user if any mismatch between the owner identity and the context is detected and/or block any connection to the site if a mismatch is detected. Once the owner-identity deduction system deduces the identity of the expected owner of the site to which a link is directed, the owner identification process of the system communicates the identity deduced by the owner-identity deduction system by producing a communication that is displayed or audibly played to the user by the device for providing a communication of the identity of the owner of the site to a user (i.e., by a display device or an audio device).

The system can further include a connection process for allowing the computing device to connect to the site if the identity of the expected owner matches a context of the content and for blocking the computing device from connecting to the site if the identity of the expected owner does not match the context of the content. The allowing or blocking of the connection to the site may be automated via software of the system or can require user input via the input device. In embodiments that include automatic blocking of connections to sites in which the owner identity does not match the context of the content, the system may include an override process that the user may select to override the automatic blocking and connect to the site anyway.

In some embodiments, the system further includes a mismatch reporting process for reporting to a service provider a link or content in which the site does not match the context of the content. By including a mechanism for allowing the user to report any mismatch, the system allows the reported mismatch to be used to warn other users who attempt to access the site, even if such other users do not have access to information regarding the site's owner. Reported mismatches may be transmitted from the computing device via the communications network to a remote computing device that records the reported mismatch as an indication of a potential phishing site, analyzes it for positive identification as a phishing site, or both. Such reported mismatches may be received on the remote computing device by a service provider who maintains such records and performs such analyses for the benefit of other users of the system or for the benefit of third parties.

In some embodiments, the system can incorporate site owner information into an app. For example, when the user moves a cursor controlled by an input device (e.g., a mouse) over a link in an email, the link site's owner is displayed. Likewise, whenever a user moves the cursor controlled by the input device over a clickable area within an email, the site's owner can be displayed automatically. Similarly, the system can automatically display the site's owner when the cursor is moved by the input device over one or more clickable areas within a web page. Whenever the cursor of the input device is positioned over the clickable area, the identity of the owner of the site is displayed automatically. This feature allows the user to avoid clicking on bad or malicious links altogether.

The system also features a method for preventing exposure to Trojan malware and other malware by preventing a connection to a phishing site. The method includes the step of: (a) providing a system that includes: (i) a computing device having a processor and an associated memory, wherein the computing device is communicatively connected to a communications network; and (ii) a software application being operated on the computing device, wherein the software application provides content and a link to a site, and wherein the software application is capable of allowing the link to the site to be selected so that the computing device connects to the site. The method further includes the steps of: (b) communicating an identity of an owner of the site using an owner identification process and a device for providing a communication of the identity of the owner of the site, wherein if the identity of the owner of the site does not match a context of the content, the site is deemed potentially to be a phishing site.

In some embodiments, step (b) of the method further including the step of: automatically displaying the identity of the owner of the site when an input device moves over or near to the link.

The method can also include the step of: (c) connecting or not connecting the computing device to the site based on a comparison by the user of the identity of the owner of the site to the context of the content.

The method can also include the step of: (d) allowing the computing device to automatically connect to the site if the identity of the owner matches a context of the content and automatically blocking the computing device from connecting to the site if the identity of the expected owner does not match the context of the content.

The method can also include sending a report of any potential phishing site to a service provider.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for preventing exposure to Trojan malware and other malware by preventing a connection to a phishing site, the system comprising:
a computing device that is communicatively connected to a communications network;
a software application being operated on the computing device, wherein the software application provides content and a link to a site, and wherein the software application is capable of allowing the link to the site to be selected so that the computing device connects to the site;
an owner identification process to communicate an identity of an owner of the site; and
a device for providing a communication of the identity of the owner of the site to a user.

2. The system of claim 1, wherein the link comprises a URL name, a path name of a URL, a domain name of a URL, or a subdomain of a URL; and
wherein the identity comprises an owner name, a URL name, a path name of a URL, a domain name of a URL, a subdomain of a URL, a derivative of one of the foregoing, or an alias representing one of the foregoing.

3. The system of claim 1, wherein the device for providing the communication of the identity of the owner of the site comprises:
(i) a display device, wherein the communication comprises a visual representation of the identity of the owner of the site that is displayed on the display device; or
(ii) an audio device, wherein the communication comprises an audible representation of the identity of the owner of the site that is played by the audio device.

4. The system of claim 3, further comprising a wireless or a wired communicative connection between the computing device and the device for providing the communication of the identity of the owner of the site.

5. The system of claim 1, wherein the device for providing a communication of the identity of the owner of the site is a component of the computing device.

6. The system of claim 1, wherein the content provides context that is deducible by the user.

7. The system of claim 1, further comprising an input device for selecting the link to connect to the site.

8. The system of claim 1, wherein the content comprises text or images displayed on a web page or in an email, text message, instant message, or another electronic message, from which context is determinable by the user.

9. The system of 1, further comprising an owner display process for automatically displaying the identity of the owner of the site when an input device moves over or near to the link.

10. A system for preventing exposure to Trojan malware and other malware by preventing a connection to a phishing site, the system comprising:
a computing device that is communicatively connected to a communications network;
a software application being operated on the computing device, wherein the software application provides content and a link to a site, and wherein the software application is capable of allowing the link to the site to be selected so that the computing device connects to the site;
an owner-identity deduction system for deducing an identity of an expected owner of the site;
an owner identification process to communicate the identity deduced by the owner-identity deduction system;
a device for providing a communication of the identity of the owner of the site to a user; and
a connection process for allowing the computing device to connect to the site if the identity of the expected owner matches a context of the content and for blocking the computing device from connecting to the site if the identity of the expected owner does not match the context of the content.

11. The system of claim 10, wherein the link comprises a URL name, a path name of a URL, a domain name of a URL, or a subdomain of a URL; and
wherein the identity comprises an owner name, a URL name, a path name of a URL, a domain name of a URL, a subdomain of a URL, a derivative of one of the foregoing, or an alias representing one of the foregoing.

12. The system of claim 10, wherein the device for providing the communication of the identity of the owner of the site comprises:
(i) a display device, wherein the communication comprises a visual representation of the identity of the owner of the site that is displayed on the display device; or
(ii) an audio device, wherein the communication comprises an audible representation of the identity of the owner of the site that is played by the audio device.

13. The system of claim 12, further comprising a wireless or a wired communicative connection between the computing device and the device for providing the communication of the identity of the owner of the site.

14. The system of claim 10, wherein the device for providing a communication of the identity of the owner of the site is a component of the computing device.

15. The system of claim 10, wherein the content provides context that is deducible by the user.

16. The system of claim 10, further comprising an input device for selecting the link to connect to the site.

17. The system of claim 10, wherein the content comprises text or images displayed on a web page or in an email, text message, instant message, or another electronic message, from which context is determinable by the user.

18. The system of claim 10, further comprising a mismatch reporting process for reporting to a service provider a link or content in which the site does not match the context of the content.

19. A method for preventing exposure to Trojan malware and other malware by preventing a connection to a phishing site, the method comprising the steps of:
(a) providing a system comprising:
(i) a computing device comprising a processor and an associated memory, wherein the computing device is communicatively connected to a communications network; and
(ii) a software application being operated on the computing device, wherein the software application provides content and a link to a site, and wherein the software application is capable of allowing the link to the site to be selected so that the computing device connects to the site;
(b) communicating an identity of an owner of the site using an owner identification process and a device for providing a communication of the identity of the owner of the site,
wherein if the identity of the owner of the site does not match a context of the content, the site is deemed potentially to be a phishing site.

20. The method of claim 19, further comprising the step of:
(c) connecting or not connecting the computing device to the site based on a comparison by the user of the identity of the owner of the site to the context of the content.

21. The method of claim 19, further comprising the step of:
(d) allowing the computing device to automatically connect to the site if the identity of the owner matches a context of the content and automatically blocking the computing device from connecting to the site if the identity of the expected owner does not match the context of the content.

22. The method of claim 19, wherein step (b) of the method further comprises the step of:
(e) automatically displaying the identity of the owner of the site when an input device moves over or near to the link.

23. The method of claim 19, further comprising the step of:
(f) sending a report of any potential phishing site to a service provider.
